(19) United States
(12) Patent Application Publication
(10) Pub. No.: US 2021/0127266 A1
(43) Pub. Date: Apr. 29, 2021

(54) CLOUD COMPUTING WITH DYNAMIC CLOUD

(71) Applicant: Elektrobit Automotive Gmbh, Erlangen (DE)

(72) Inventor: Claus STELLWAG, Schwalbach a. Ts. (DE)

(21) Appl. No.: 17/078,886

(22) Filed: Oct. 23, 2020

(30) Foreign Application Priority Data
Oct. 25, 2019 (EP) 19205362

(51) Int. Cl. H04W 12/06; H04W 4/02; H04W 4/44; G06F 9/50

(52) U.S. Cl. CPC H04W 12/0609; H04W 4/023; H04W 84/18; G06F 9/5083; H04W 4/44

(57) ABSTRACT

Operating a cloud computing system with at least one stationary base and mobile components includes: detecting that a first mobile component is located in a spatial proximity of the stationary base, and incorporating a first mobile component into the cloud computing system. Following successful incorporation, there is an allocation of computing capacity of the first mobile component for the cloud computing system. If the first mobile component leaves the spatial proximity of the stationary base, the first mobile component is removed from the cloud computing system.

### BACKGROUND OF THE INVENTION

### 1. Field of the Invention

The present invention relates to a method, to a computer program containing instructions and to a device for operating a cloud computing system with at least one stationary base and mobile components.

### 2. Description of the Related Art

Cloud computing describes the approach of providing information technology infrastructures via a computer network without these having to be installed on local computers. Cloud computing systems generally contain memory space, computing capacity or application software as a service. A cloud typically exists in a computing center, which may possibly be in the form of a distributed computing center. The terms computer cloud or data cloud have become established in this sector and will be used below.

### SUMMARY OF THE INVENTION

One object of the present invention is to provide a solution that allows the operation of a dynamic cloud computing system.

This object may be achieved by a method for operating a cloud computing system, by a computer program containing instructions, by a device for operating a cloud computing system and, by a motor vehicle and a mobile user device.

According to a first aspect of the invention, a method for operating a cloud computing system with at least one stationary base and mobile components comprises the steps of:
detecting that a first mobile component is located in the spatial proximity of the stationary base;
incorporating the first mobile component into the cloud computing system, and
allocating computing capacity of the first mobile component for the cloud computing system.

According to a further aspect of the invention, a computer program comprises instructions that, when they are executed by a computer, prompt the computer to execute the following steps for operating a cloud computing system with at least one stationary base and mobile components:
detecting that a first mobile component is located in the spatial proximity of the stationary base;
incorporating the first mobile component into the cloud computing system, and
allocating computing capacity of the first mobile component for the cloud computing system.

The term computer should in this case be understood in the broad sense. In particular, it also comprises workstations, distributed systems and other processor-based data processing devices.

The computer program may for example be provided for electronic retrieval or be stored on a computer-readable storage medium.

According to a further aspect of the invention, a device for operating a cloud computing system with at least one stationary base and mobile components has:
a position inspection module for detecting that a first mobile component is located in the spatial proximity of the stationary base;
a subscriber management module for incorporating the first mobile component into the cloud computing system, and
a capacity management module for allocating computing capacity of the first mobile component for the cloud computing system.

In a solution according to an aspect of the invention, a dynamic cloud is established using stationary components or subscribers, what are known as bases or base stations, and mobile components or subscribers. In contrast to a conventional cloud that exists in a computing center or a distributed computing center, a cloud is generated as and when needed according to the invention. In this case, the individual subscribers, in particular the mobile components, make available portions of their respective available computing capacity. Such a cloud computing system has the advantage that only low computing capacities need to be kept available in the base stations, since considerably greater computing capacities are able to be provided by the mobile components. The latency times between the subscribers of the cloud computing system are additionally lower than in the case of a pure cloud approach, since there is spatial proximity between the subscribers. Dynamic clouds make it possible to implement new business models, for example by billing the computing capacities that are provided.

The term stationary should be understood here to mean that a base is designed to be at least temporarily stationary, even if it is possible in principle to move the base to another location.

According to one aspect of the invention, the first mobile component is removed from the cloud computing system when it leaves the spatial proximity of the stationary base. If a mobile component moves away from the base again, it is at some point no longer able to be used, or at least no longer able to be used expediently, by the cloud computing system, for example because a connection to the base is broken or desired latency times are no longer able to be ensured. The point at which a mobile component is definitively removed from the cloud computing system is defined by a person skilled in the art. There may in particular also be provision for a mobile component, depending on the specific spatial distance, to be used only for certain tasks, whereas it is excluded from other tasks.

According to one aspect of the invention, position information is provided by the mobile components. On the basis of the provided position information, it is easily possible to determine the distance between the base and a mobile component.

According to one aspect of the invention, route information or maneuver data is provided by the mobile components. On the basis of this information, it is possible to determine how long the computing capacity of a mobile component will be available. This allows better planning as to how the computing capacities are able to be used.

According to one aspect of the invention, the first mobile component is incorporated into the cloud computing system and a task is allocated to the first mobile component by the base. The stationary subscribers thus function as masters, whereas the mobile components constitute slaves. This has the advantage that any dynamic cloud is managed and controlled locally by the base, such that there is no need for any central control.

According to one aspect of the invention, the mobile components are motor vehicles or mobile user devices. Real-time applications in a traffic environment require a very prompt response. By way of example, hazards recognized by a vehicle should be propagated to other traffic participants as quickly as possible. Future applications that require a high computing capacity, on the one hand, but also need to be calculated as locally as possible, since a minimum time delay is required, on the other hand, are additionally being contemplated. Computing capacities for such tasks are kept available for this reason in modern mobile radio stations. Since increasingly large computing capacities are being kept available both in motor vehicles and in mobile devices and often remain at least partly unused, it makes sense also to use the computing capacities available in motor vehicles or mobile devices for such applications.

According to one aspect of the invention, the computing capacity of the first mobile component is used to validate a certificate or to construct a surroundings model in the base. These are typical tasks that require a high computing capacity but need to be calculated as locally as possible with regard to a minimum time delay. The solution according to the invention is therefore ideally suited to such tasks.

According to one aspect of the invention, a cloud computing system with at least one stationary base and mobile components has a device according to the invention or is configured so as to execute a method according to the invention for operating the cloud computing system. The base may in particular be a base station for a mobile radio service. Such a cloud computing system has the advantage that only low computing capacities need to be kept available in the base, since considerably greater computing capacities are able to be provided by the mobile components. Optimum use is thus made of the available resources.

A motor vehicle is preferably configured so as to be incorporated into a cloud computing system according to the invention and to provide computing capacity of a computer system to the cloud computing system. The motor vehicle is, for example, an autonomous or partly autonomous motor vehicle or a motor vehicle equipped with assistance systems. Motor vehicles will make increasing use of high-performance computers (HPC) in the future, in particular with regard to partly autonomous or fully autonomous driving. Motor vehicles will therefore make available large computing capacities that are not used, or are only partly used, in many situations. By virtue of the solutions according to the invention, optimum use is able to be made of these resources for additional tasks. The communication between the motor vehicle and the base may, for example, use 5G technology.

A mobile user device is preferably configured so as to be incorporated into a cloud computing system according to the invention and to provide computing capacity of a processor to the cloud computing system. The mobile user device may be for example a smartphone, a tablet or a laptop. Modern smartphones and tablets also make available large computing capacities that often remain unused. It therefore makes sense, in order to effectively use the available processing power, also to use such devices for a cloud computing system according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features of the present invention become apparent from the following description and the accompanying claims in conjunction with the figures, in which:

FIG. 1 schematically shows a method for operating a cloud computing system with at least one stationary base and mobile components;

FIG. 2 schematically shows a first embodiment of a device for operating a cloud computing system with at least one stationary base and mobile components;

FIG. 3 schematically shows a second embodiment of a device for operating a cloud computing system with at least one stationary base and mobile components;

FIG. 4 schematically shows a motor vehicle that is configured for use in a cloud computing system according to the invention;

FIG. 5 schematically shows a mobile user device that is configured for use in a cloud computing system according to the invention; and

FIGS. 6A-6C schematically show the use of a motor vehicle in a cloud computing system according to the invention.

### DETAILED DESCRIPTION OF THE PRESENTLY PREFERRED EMBODIMENTS

For a better understanding of the principles of the present invention, embodiments of the invention are described below in greater detail with reference to the figures. The same reference signs are used in the figures for identical or functionally identical elements, and are not necessarily described again for each figure. It is to be understood that the invention is not restricted to the illustrated embodiments, and that the described features may also be combined or modified without departing from the scope of protection of the invention as defined in the accompanying claims.

FIG. 1 schematically shows a method for operating a cloud computing system with at least one stationary base and mobile components. The mobile components may be, for example, motor vehicles or mobile user devices. The base may in particular be a base station for a mobile radio service. In a first step, it is detected in step 10 that a first mobile component is located in the spatial proximity of the stationary base. This may be performed. for example, on the basis of position information, route information or maneuver data that are provided by the mobile components. The first mobile component is then incorporated into the cloud computing system in step 11. Following successful incorporation in step 11, there is allocation in step 12 of computing capacity of the first mobile component for the cloud computing system. The computing capacity may be used, for example, to validate a certificate or to construct a surroundings model in the base. The incorporation in step 11 and allocation of a task to the first mobile component are in this case preferably performed by the base. If the first mobile component leaves the spatial proximity of the stationary base again at a later time, it is removed from the cloud computing system in step 13.

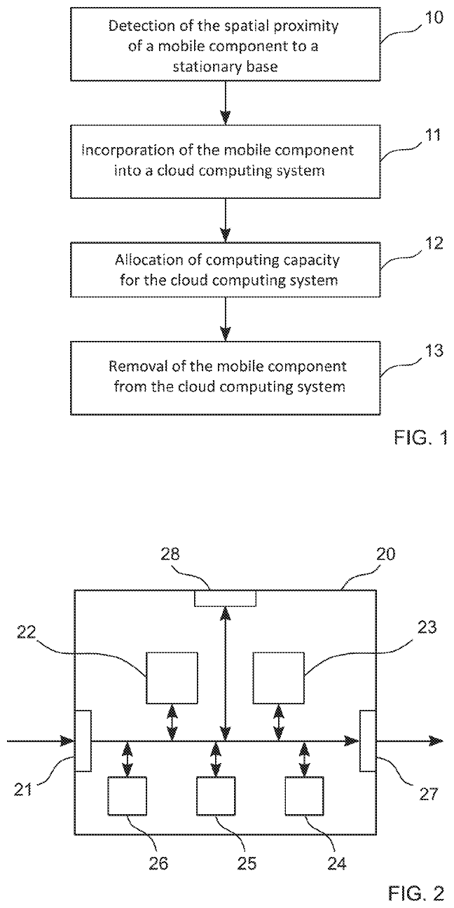

FIG. 2 shows a simplified schematic illustration of a first embodiment of a device 20 for operating a cloud computing system with at least one stationary base and mobile components. The device 20 is preferably part of the base. The mobile components may be, for example, motor vehicles or mobile user devices. The base may in particular be a base station for a mobile radio service. The device 20 has an input 21 via which data from a mobile component are able to be received. A position inspection module 22 detects that a first mobile component is located in the spatial proximity of the stationary base. To this end, the position inspection module 22 may, for example, evaluate position information, route information or maneuver data that are provided by the mobile components. A subscriber management module 23 then incorporates the first mobile component into the cloud computing system. Following successful incorporation, computing capacity of the first mobile component is allocated to the cloud computing system by way of a capacity management module 24. The computing capacity may be used, for example, to validate a certificate or to construct a surroundings model in the base. If the first mobile component leaves the spatial proximity of the stationary base again at a later time, it is removed from the cloud computing system again by the subscriber management module 23.

The position inspection module 22, the subscriber management module 23 and the capacity management module 24 may be controlled by a controller 25. Settings of the position inspection module 22, the subscriber management module 23, the capacity management module 24 or the controller 25 may possibly be changed via a user interface 28. The data that accrue in the device 20 may, if necessary, be stored in a memory 26 of the device 20, for example for later evaluation or for use by the components of the device 20. Data may likewise be output via an output 27 of the device 20. The position inspection module 22, the subscriber management module 23, the capacity management module 24 and the controller 25 may be implemented as dedicated hardware, for example as integrated circuits. They may of course however also be implemented partly or fully in combination or as software that runs on a suitable processor, for example on a GPU or a CPU. The input 21 and the output 27 may be implemented as separate interfaces or as a combined bidirectional interface.

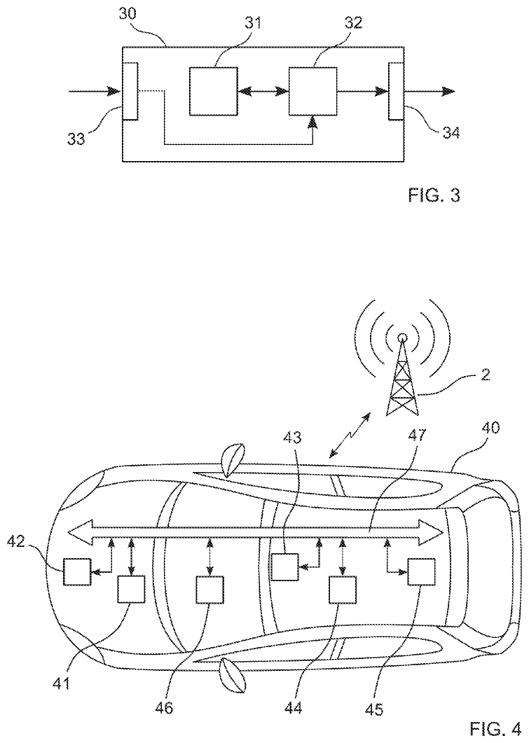

FIG. 3 shows a simplified schematic illustration of a second embodiment of a device 30 for operating a cloud computing system with at least one stationary base and mobile components. The device 30 has a processor 32 and a memory 31. The device 30 is for example a computer or a graphics chip. The memory 31 contains instructions that, when they are executed by the processor 32, prompt the device 30 to execute the steps according to one of the described methods. The instructions stored in the memory 31 thus embody a program that is able to be executed by the processor 32 and that implements the method according to the invention. The device 30 has an input 33 for receiving information, for example data from a motor vehicle or a mobile user device. Data generated by the processor 32 are provided via an output 34. These data may also be stored in the memory 31. The input 33 and the output 34 may be combined to form a bidirectional interface.

The processor 32 may comprise one or more processor units, for example microprocessors, digital signal processors or combinations thereof.

The memories 26, 31 of the described devices may contain both volatile and non-volatile memory areas, and may comprise a wide variety of storage devices and storage media, for example hard disks, optical storage media or semiconductor memories.

FIG. 4 schematically shows a motor vehicle 40 that is configured for use in a cloud computing system according to the invention. The motor vehicle 40 is, for example, an autonomous or partly autonomous motor vehicle 40 or a motor vehicle 40 equipped with assistance systems 42. The motor vehicle 40 has at least one computer system 41 that is able to be used in particular by an assistance system 42 of the motor vehicle 40, for example to process sensor data. The motor vehicle 40 additionally has a sensor system 43 by way of which sensor data may be detected. The sensor system 43 may in particular comprise surroundings recognition sensors, for example ultrasound sensors, laser scanners, radar sensors, lidar sensors or cameras. In this example, further components of the motor vehicle 40 are a navigation system 44 and a data transfer unit 45. A connection to a base 2 of a cloud computing system may be set up by way of the data transfer unit 45. The motor vehicle 40 is configured so as to be incorporated into the cloud computing system and to provide computing capacity of the computer system 41 to the cloud computing system. A memory 46 is present for storing data. Data are exchanged between the various components of the motor vehicle 40 via a network 47.

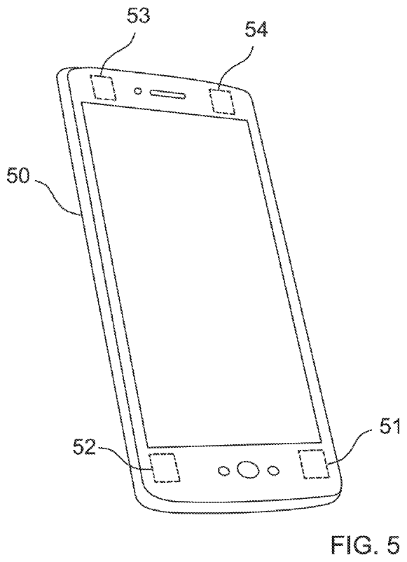

FIG. 5 schematically shows a mobile user device 50 that is configured for use in a cloud computing system according to the invention. In this example, the mobile user device 50 is a smartphone. Further examples of mobile user devices 50 are tablets, laptops, etc. The mobile user device 50 has a processor 51 that is able to be used in particular to execute applications of the mobile user device 50. The processor 51 may in this case access a memory 52 of the mobile user device 50. A GPS module 53 (GPS: Global Positioning System) makes it possible to determine the position of the mobile user device 50 and may additionally be used in the context of route planning and navigation. A connection to a base 2 of a cloud computing system may be set up by way of a data transfer unit 54. The mobile user device 50 is configured so as to be incorporated into the cloud computing system and to provide computing capacity of the processor 51 to the cloud computing system.

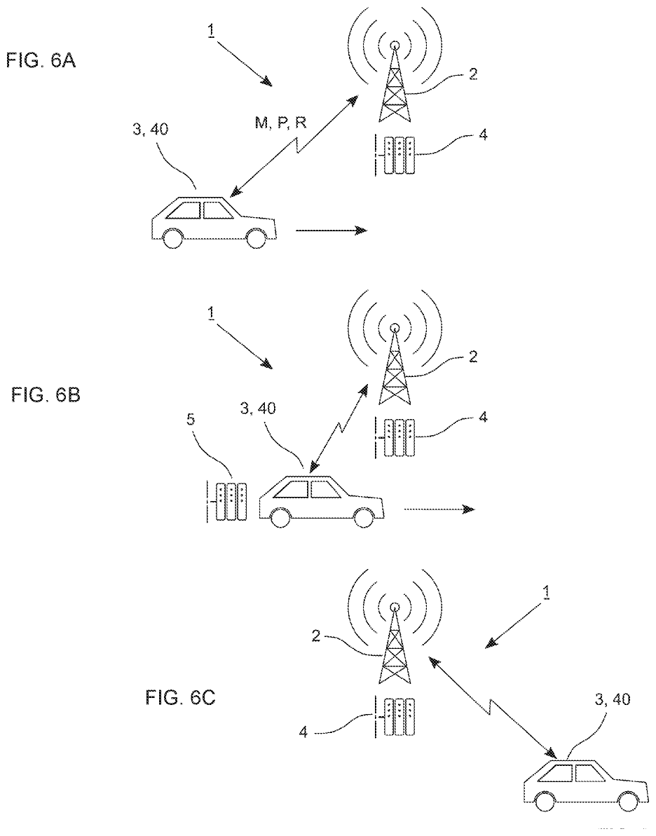

FIG. 6A-6C schematically show the use of a motor vehicle 40 as mobile component 3 in a cloud computing system 1 according to the invention. The base 2 is in this case a base station for a mobile radio service. The base 2 has a local server 4 that spans a local cloud. A motor vehicle 40 approaching the base 2 transmits position information P, route information R or even maneuver data M to the base 2. This is illustrated in FIG. 6A. If the motor vehicle 40 is located in a desired spatial proximity to the base 2, the resources available in the motor vehicle 40, in particular a computer system, are incorporated into the local cloud and are then likewise part of the local cloud. The computer system in the motor vehicle 40 thus functions as a virtual server 5. This is illustrated in FIG. 6B. If the motor vehicle 40, as shown in FIG. 6C, leaves the spatial proximity to the base again, the connection to the virtual server 5 in the motor vehicle 40 is closed again, that is to say the motor vehicle 40 leaves the local cloud.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for operating a cloud computing system (1) with at least one stationary base (2) and mobile components (3), the method comprising:
detecting (10) that a first mobile component (3) is located in a spatial proximity of the stationary base (2);
incorporating (11) a first mobile component (3) into the cloud computing system (1); and
allocating (12) computing capacity of the first mobile component (3) for the cloud computing system (1).

2. The method as claimed in claim 1, wherein the first mobile component (3) is removed from the cloud computing system (1) when it leaves the spatial proximity of the stationary base (2).

3. The method as claimed in claim 1, wherein position information (P) is provided by the mobile components (3).

4. The method as claimed in claim 3, wherein route information (R) or maneuver data (M) is provided by the mobile components (3).

5. The method as claimed in claim 1, wherein the first mobile component (3) is incorporated (11) into the cloud computing system (1), the method further comprising allocating, by the base (2), a task to the first mobile component (3).

6. The method as claimed in claim 1, wherein the mobile components (3) are motor vehicles (40) or mobile user devices (50).

7. The method as claimed in claim 1, wherein the computing capacity of the first mobile component (3) is used to validate a certificate or to construct a surroundings model in the base (2).

8. A non-transitory computer-readable medium storing a computer program containing instructions that, when they are executed by a computer, cause the computer to execute the steps of the method as claimed in claim 1 for operating the cloud computing system (1).

9. A device (20) for operating a cloud computing system (1) with at least one stationary base (2) and mobile components (3), the device comprising:
a position inspection module (22) configured to detect (10) that a first mobile component (3) is located in a spatial proximity of the stationary base (2);
a subscriber management module (23) configured to incorporate (11) a first mobile component (3) into the cloud computing system (1); and
a capacity management module (24) configured to allocate (12) computing capacity of the first mobile component (3) for the cloud computing system (1).

10. A cloud computing system (1) with at least one stationary base (2) and mobile components (3), wherein the cloud computing system (1) has the device as claimed in claim 9 for operating the cloud computing system (1).

11. A motor vehicle (40) having a computer system (41), wherein the motor vehicle (40) is configured so as to be incorporated (11) into a cloud computing system (1) and to provide (12) computing capacity of the computer system (41) to the cloud computing system (1).

12. A mobile user device (50) having a processor (51), wherein the mobile user device (50) is configured so as to be incorporated (11) into a cloud computing system (1) and to provide (12) computing capacity of the processor (51) to the cloud computing system (1).

13. A cloud computing system (1) with at least one stationary base (2) and mobile components (3), wherein the cloud computing system (1) is configured to execute the method as claimed in claim 1 for operating the cloud computing system (1).
